(19) United States
(12) Patent Application Publication
(10) Pub. No.: US 2004/0159207 A1
(43) Pub. Date: Aug. 19, 2004

(54) Floating blade plectrum Mk. 2

(76) Inventor: Peter John Glyde, Burton on Trent (GB)

Correspondence Address: PETER J. GLYDE, 471, BURTON RD., MIDWAY, SWADLINCOTE, BURTON-ON-TRENT, DEII 7NB, GB

(21) Appl. No.: 10/645,936

(22) Filed: Aug. 25, 2003

(30) Foreign Application Priority Data
Feb. 13, 2003 (GB) GB 0303240.6
Jul. 29, 2003 (GB) GB 0317717.7

(51) Int. Cl. G10D 3/16

(52) U.S. Cl. 84/322

(57) ABSTRACT

The Floating Blade Plectrum Mk.2 is a general purpose plectrum suitable for all types of guitar playing. The floating blade plectrum Mk. 2 comprises a ‘blade’ with a ‘non-rigid attachment’ between this and two ‘rigidity layers’. The ‘rigidity layers’ are enclosed between two ‘grip layers’. The ‘moment plates’ are attached to the ‘grip layers’ and are made of a thin semi-rigid material. There are ‘mechanical grips’ provided on the upper side of the lower ‘moment plate’ and the lower side of the upper ‘moment plate’. There is a ‘tension fixing’ immediately behind the trailing edges of the ‘moment plates’. There are two ‘grip layer contour pieces’. The presence of the ‘moment plates’ and ‘mechanical grips’ increases the maximum rigidity of the plectrum. The presence of the curvature of the ‘moment plates’, the ‘tension fixings’ and ‘grip layer contour pieces’ gives a softer strum for minimal applied pressure.

### CROSS-REFERENCE TO RELATED APPLICATIONS

U.S. patent application Ser. No.; dispatched 04/07/03, received 15 Jul. 2003 by USPTO, no receipt received by applicant @ 29 Jul. 2003.

### BACKGROUND OF THE INVENTION

This invention relates to a floating blade plectrum suitable for playing a steel strung acoustic guitar.

### STATEMENT REGARDING FEDERALLY SPONSORED RESEARCH DEVELOPMENT

Not applicable.

### REFERENCE TO SEQUENCE LISTING, A TABLE, OR A COMPUTER PROGRAM LISTING COMPACT DISK APPENDIX.

Not applicable.

### BRIEF SUMMARY OF THE INVENTION

A plectrum is one means of playing the strings of a steel strung acoustic guitar. Typically a plectrum is an egg shaped piece of thin plastic approx. 1″ long by ¾″ wide. It is usually held between the thumb and first finger of the playing hand in a pen-holding grip. There are a number of ways in which the plectrum can be used to play the guitar. The strings can be sounded in rapid succession, i.e. strummed or picked individually, i.e. single note playing. A combination of the two styles of playing is called ‘flat picking’. Conventional plectra are supplied in various thicknesses depending on the style and loudness of playing, e.g. soft strumming, loud strumming, single note playing and flat picking. The disadvantages of using conventional plectra are as follows. Firstly, the player cannot easily change the style of playing, say from soft to loud strumming as this requires putting down one plectrum and picking up the next. Secondly, the sound quality obtained with thin plectra is poor due to high plectrum ‘clatter’ or ‘white noise’ compared to the actual musical notes the instrument is producing. Thirdly, the dynamic control, i.e. the ability to play very loudly and very softly with the same plectrum is poor. Fourthly, conventional plectra are difficult to grip and tend to move and leave the fingers when in use. Fifthly, for fast flat picking and smooth strumming it is advantageous to have the plectrum stiffer on the down stroke than on the up stroke, conventional plectra cannot provide this. The floating blade plectrum is a single general purpose plectrum which eliminates all the listed disadvantages. The floating blade plectrum Mk. 2 incorporates new features to enhance the overall performance of the floating blade plectrum.

### BRIEF DESCRIPTION OF THE SEVERAL VIEWS OF THE DRAWING

FIG. 1 shows in perspective the ‘blade’ 1 with ‘non-rigid attachment’ 2.

FIG. 2 shows in perspective the ‘blade’ 1 with ‘non-rigid attachment’ 2 fixed to the ‘rigidity layers’ 3&4.

FIG. 3 shows in perspective the above with the ‘grip layers’ 5&6 ‘moment plates’ 11&12 and ‘tension fixings’ 13&14.

FIG. 4 shows in perspective the above with the ‘grip layer contour pieces’ 15&16 to make the complete floating blade plectrum Mk. 2.

### DETAILED DESCRIPTION OF THE INVENTION

A conventional plectrum is typically an egg-shaped piece of thin plastic approx. 1″ long by ¾″ wide. The Floating Blade Plectrum Mk.2 is totally different in operation and construction retaining only a short relatively thick blade of approx. ½″ long by ¾″ wide.

According to the present invention there is provided a ‘blade’ of relatively thick plastic material with a ‘non-rigid attachment’ between this and two ‘rigidity layers’. The upper and lower ‘rigidity layers’ are each made of a soft flexible material of uniform thickness, the upper layer being of a greater thickness than the lower. The ‘rigidity layers’ can be contoured to adjust the rigidity they confer to the plectrum. The ‘rigidity layers’ are enclosed between two ‘grip layers’. Each ‘grip layer’ is made of soft flexible non-slip material or a soft flexible material coated with a soft flexible non-slip surface. Each ‘grip layer’ is of uniform thickness and the thickness of each is the same. There is a ‘moment plate’ of relatively thin semi-rigid material, one above the ‘blade’ and one below the ‘blade’ making two in all. Each ‘moment plate’ may be attached above or below the ‘grip layer’ or ‘rigidity layer’ or embedded within the ‘grip layer’ or ‘rigidity layer. Each ‘moment plate’ is ‘curved or bent’ so that the upper and lower halves of the plectrum at the ‘blade’ end are permanently open leaving the ‘blade’ able to move freely when minimal pressure is applied. There is a ‘mechanical grip’ on the underside of the component immediately in contact with the top side of the ‘blade’ and ‘non-rigid attachment’ and a ‘mechanical grip’ on the upper side of the component immediately in contact with the bottom side of the ‘blade’ and ‘non-rigid attachment’. There is a ‘tension fixing’ immediately behind the trailing edges of the upper and lower ‘moment plates’ which passes through both the upper and lower ‘grip layers’ and through all other layers. This ‘tension fixing’ may be adjustable to alter the tension in the upper and lower ‘grip layers’ and enhance the opening of the upper and lower halves of the plectrum at the ‘blade’ end. There are two ‘grip layer contour pieces’, one attached to the rear end of the upper ‘grip layer’ and one attached to the rear end of the lower ‘grip layer’, these ‘grip layer contour pieces’ enhance the gripping of the plectrum when minimal pressure is applied leaving the ‘blade’ to vibrate freely. Each ‘grip layer contour piece’ is of uniform thickness and the thickness of each is the same. Each ‘grip layer contour piece’ is made of a soft flexible non-slip material or a soft flexible material with a soft flexible non-slip coating.

The plectrum is held in a pen-holding grip between the thumb and first finger. When minimal pressure is applied this allows free movement of the ‘blade’ between the ‘rigidity layers’. When maximum pressure is exerted the ‘blade’ is held securely between the finger and the thumb. Varying the grip pressure over the two extremes gives a plectrum of infinitely varying rigidity. The presence of the ‘moment plates’ and ‘mechanical grips’ increases the sensitivity of the floating blade plectrum such that for a similar increase in grip pressure the rigidity of the plectrum is greater; the minimum rigidity is unaltered but the maximum rigidity is increased. The presence of the ‘tension fixings’, ‘grip layer contour pieces’ and ‘bending or curving’ of the ‘moment plates’ facilitates the opening of the upper and lower halves of the floating blade plectrum at the ‘blade’ end when only minimal pressure is applied improving the soft strumming performance of the plectrum. The different thickness of the ‘rigidity layers’ means that the plectrum is always stiffer on the down stroke than on the up stroke.

A specific embodiment of the invention will now be described by way of example with reference to the accompanying drawing in which

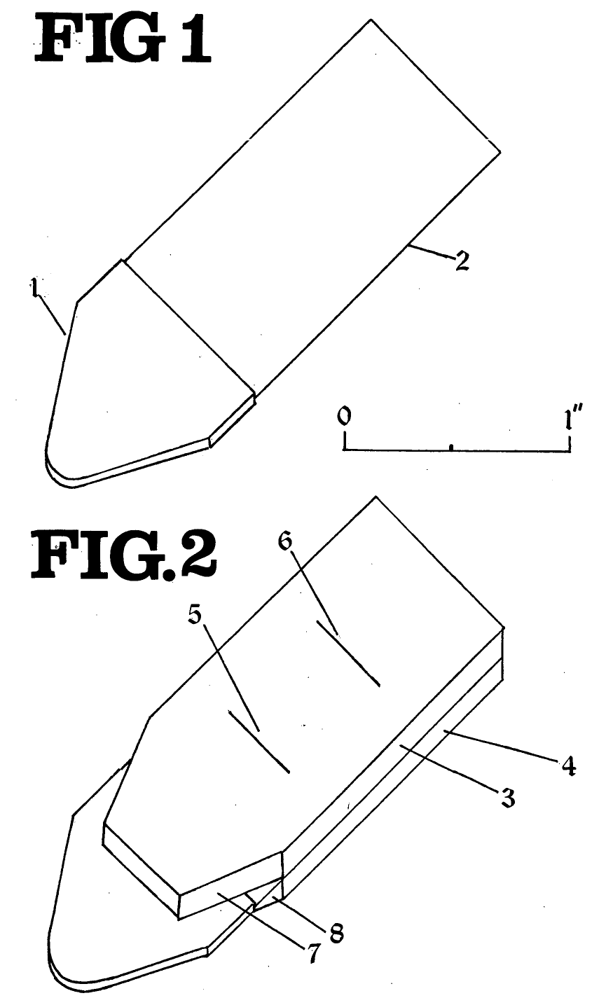

FIG. 1 shows in perspective the ‘blade’ with ‘non-rigid attachment’.

FIG. 2 shows in perspective the ‘blade’ with ‘non-rigid attachment’ fixed to the ‘rigidity layers’.

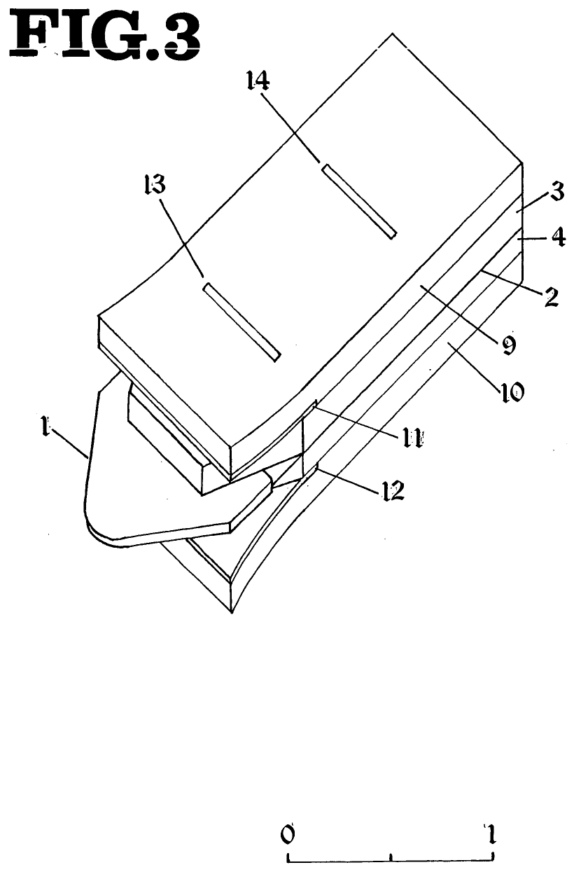

FIG. 3 shows in perspective the above with the ‘grip layers’, ‘moment plates’ and ‘tension fixings’.

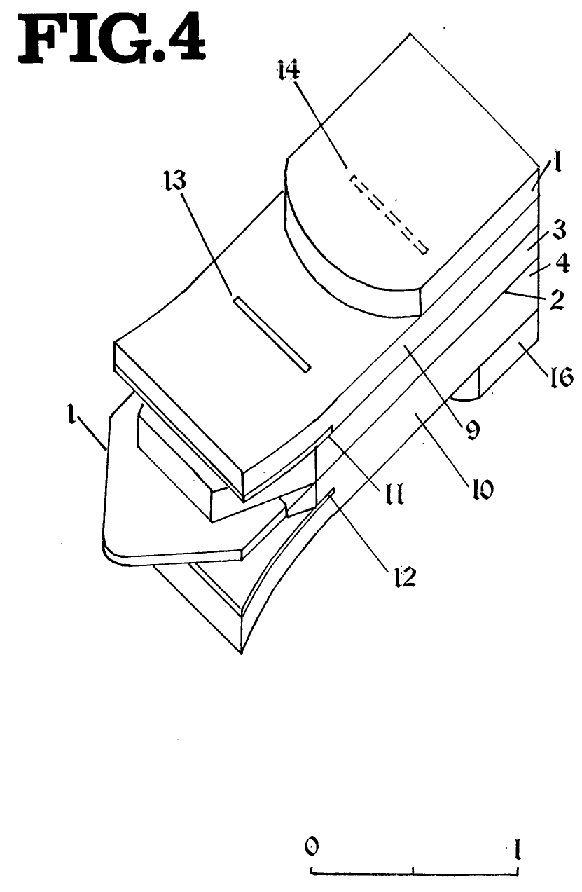

FIG. 4 shows in perspective the above with the ‘grip layer contour pieces’ to make the complete floating blade plectrum Mk. 2.

Referring to the drawings the floating blade plectrum comprises a ‘blade’ 1 of relatively thick plastic material with a ‘non-rigid attachment’ 2 as shown in FIG. 1. Upper and ‘lower rigidity layers’ 3&4 are attached by fixings 5&6 as shown in FIG. 2 using for example, staples. The ‘rigidity layers’ 3&4 have been contoured 7&8 to adjust the rigidity they confer to the plectrum as shown in FIG. 2. The ‘grip layers’ 9&10 are attached to the ‘rigidity layers’ 3&4 as shown in FIG. 3 by, for example, adhesive backing already present on one side of the ‘grip layers’ 9&10 or by the application of a rubber solution based adhesive which is soft and flexible on setting. The ‘moment plates’ 11&12 are attached to the ‘grip layers’ 9&10, the underside of the upper ‘grip layer’ and the upper side of the lower ‘grip layer’ by, for example, the application of a rubber solution based adhesive. The trailing edge of each ‘moment plate’ extends beyond the rear edge of the ‘blade’. Each ‘moment plate’ is ‘curved or bent’ and a ‘mechanical grip’, for example the underside of three fitted staples, is provided on the underside of the upper ‘moment plate’ and the upper side of the lower ‘moment plate’. The ‘tension fixings’ 13&14, for example heavy duty staples, are fitted with 13 immediately behind the trailing edges of the upper and lower ‘moment plates’, 11&12. The ‘grip layer contour pieces’, 15&16 are fitted as shown in FIG. 4, they are attached to the ‘grip layers’ by, for example, adhesive backing already present on one side of the ‘grip layer contour pieces’ or the application of a rubber solution based adhesive which is soft and flexible on setting.

What I claim as my invention is:

1. A floating blade plectrum Mk. 2 comprising ‘moment plates’ of thin semi-rigid material which are ‘curved or bent’ and in which there is a
‘mechanical grip’ on the underside of the component immediately in contact with the top side of the ‘blade’ and ‘non-rigid attachment’ and a ‘mechanical grip’ on the upper side of the component immediately in contact with the bottom side of the ‘blade’ and ‘non-rigid attachment’ and in which there are two
‘tension fixings’ one of which is immediately behind the trailing edge of the upper and lower ‘moment plates’ which passes through both the upper and lower ‘grip layers’ and through all other layers and which may be adjustable to alter the tension in the upper and
lower ‘grip layers’ to enhance the opening of the upper and lower halves of the plectrum at the ‘blade’ end and in which there are two
‘grip layer contour pieces’ one attached to the rear end of the upper ‘grip layer’ and one attached to the rear end of the lower ‘grip layer’ to enhance the gripping of the plectrum when only minimal pressure is applied leaving the ‘blade’ to vibrate freely.

2. A floating blade plectrum Mk.2 as claimed in claim 1 in which the ‘moment plates’ are curved as shown in the drawings and the
‘moment plates’ are made of relatively thin high density polyethylene sheet and the
‘mechanical grip’ on the underside of the upper ‘moment plate’ is provided by the underside of three fitted staples and the
‘mechanical grip’ on the upper side of the lower ‘moment plate’ is provided by the underside of three fitted staples and the
‘tension fixings’ are provided by heavy duty staples, the first of which is immediately behind the trailing edge of the upper and lower ‘moment plates’, and the second is behind the first approx. mid-way between the first staple and the rear end of the plectrum and both of which pierce all the layers of the plectrum including the ‘non-rigid attachment’ and each
‘grip layer contour piece’ is made from adhesive backed non-slip micro-cellular sponge rubber or non-slip micro-cellular sponge rubber and attached by a rubber solution based adhesive which is soft and flexible on setting.
